(19) United States
(12) Patent Application Publication
(10) Pub. No.: US 2023/0187877 A1
(43) Pub. Date: Jun. 15, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Tetsuya MIYAMURA, Mie (JP); Yutaka KOBAYASHI, Mie (JP)

(21) Appl. No.: 17/926,485

(22) PCT Filed: May 17, 2021
(86) PCT No.: PCT/JP2021/018605

§ 371 Date: Nov. 18, 2022

(30) Foreign Application Priority Data
Jun. 5, 2020 (JP) 2020-098291

(51) Int. Cl. H01R 13/641; H01R 13/631; H01R 13/635; H01R 24/84

(52) U.S. Cl. CPC H01R 13/641; H01R 13/631; H01R 13/635; H01R 24/84

(57) ABSTRACT

A connector is provided with a first housing, a second housing connectable to and separable from the first housing, a spring member, a first pressing portion and a second pressing portion arranged at positions to accumulate a resilient force in the spring member according to connection of the first housing and the second housing, a first pressure receiving portion and a second pressure receiving portion arranged to receive a resilient restoring force in a direction to connect the first housing and the second housing from the spring member having the resilient force accumulated therein, and a first holding portion and a second holding portion for holding the spring member in a resilient force accumulating state of accumulating the resilient force by the first pressing portion and the second pressing portion only from start to a halfway state of the connection of the first housing and the second housing.

### TECHNICAL FIELD

The present disclosure relates to a connector.

### BACKGROUND

Patent Document 1 discloses a connector configured to prevent a male connector and a female connector from being left in an incompletely connected state. In the process of connecting the both connectors, a coil spring is resiliently deformed by a slide member of the male connector butting against a lock arm of the female connector. If a connecting operation is interrupted with the both connectors left in the incompletely connected state, the both connectors are separated by a resilient force accumulated in the coil spring. Thus, the both connectors are prevented from being left in the incompletely connected state. If the both connectors reach a complete connection position, the lock arm is disengaged from the slide member and the resilient force accumulated in the coil spring is released.

### PRIOR ART DOCUMENT

### Patent Document

Patent Document 1: JP 2018-195423 A

### SUMMARY OF THE INVENTION

### Problems to be Solved

To reliably separate the both connectors when the both connectors are in the incompletely connected state, a sufficient resilient force needs to be accumulated in the coil spring also just before the both connectors reach a completely connected state. However, since the coil spring continues to be resiliently deformed until the both connectors reach the completely connected state, the resilient force accumulated in the coil spring becomes excessively large immediately before the both connectors reach the completely connected state. The resilient force accumulated in the coil spring acts as connection resistance of the both connectors. Thus, the above connector has a problem that connection resistance is large and workability is not good.

The connector of the present disclosure was completed on the basis of the above situation and aims to reduce connection resistance.

### Means to Solve the Problem

The present disclosure is directed to a connector with a first housing, a second housing connectable to and separable from the first housing, a spring member, a pressing portion arranged at a position to accumulate a resilient force in the spring member according to connection of the first and second housings, a pressure receiving portion arranged to receive a resilient restoring force in a direction to connect the first and second housings from the spring member having the resilient force accumulated therein, and a holding portion for holding the spring member in a resilient force accumulating state of accumulating the resilient force by the pressing portion only from start to a halfway state of the connection of the first and second housings.

### Effect of the Invention

According to the present disclosure, it is possible to reduce connection resistance.

### BRIEF DESCRIPTION OF THE DRAWINGS

FIG. 1 is a perspective view showing a state where a spring member is mounted in a first housing in a first embodiment when viewed obliquely from an upper front side.

FIG. 2 is a perspective view showing the state where the spring member is mounted in the first housing when viewed obliquely from an upper rear side.

FIG. 3 is a perspective view of a second housing when viewed obliquely from a lower front side.

FIG. 4 is a plan view in section showing a state where the first and second housings in an unconnected state are facing each other.

FIG. 5 is a plan view in section showing a state where the connection of the first and second housings is started.

FIG. 6 is a plan view in section showing a state where the spring member is held in a resilient force accumulating state in the process of connecting the first and second housings.

FIG. 7 is a plan view in section showing a state where the spring member is switched from the resilient force accumulating state to a resilient force releasing state in the process of connecting the first and second housings.

FIG. 8 is a plan view in section showing a state where the connection of the first and second housings is completed.

FIG. 9 is a perspective view showing a mounted state of a slider and a spring member in a first housing in a second embodiment when viewed obliquely from above.

FIG. 10 is a perspective view of the first housing when viewed obliquely from above.

FIG. 11 is a perspective view showing a state where the slider, the spring member and a receiving member are separated when viewed obliquely from above.

FIG. 12 is a perspective view of the slider when viewed obliquely from below.

FIG. 13 is a perspective view of a second housing when viewed obliquely from below.

FIG. 14 is a front view in section showing a connected state of the first and second housings when viewed from the side of the second housing.

FIG. 15 is a section along X-X of FIG. 14 showing a state where the first and second housings in an unconnected state are facing each other.

FIG. 16 is a section along Y-Y of FIG. 14 showing a state where the connection of the first and second housings is started.

FIG. 17 is a section along Y-Y showing a state where the spring member is held in a resilient force accumulating state in the process of connecting the first and second housings.

FIG. 18 is a section along Y-Y showing a state where the spring member is switched from the resilient force accumulating state to a resilient force releasing state in the process of connecting the first and second housings.

FIG. 19 is a section along X-X showing the state where the spring member is switched from the resilient force accumulating state to the resilient force releasing state in the process of connecting the first and second housings.

FIG. 20 is a section along X-X showing a state where the connection of the first and second housings is completed.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing, a second housing connectable to and separable from the first housing, a spring member, a pressing portion arranged at a position to accumulate a resilient force in the spring member according to connection of the first and second housings, a pressure receiving portion arranged to receive a resilient restoring force in a direction to connect the first and second housings from the spring member having the resilient force accumulated therein, and a holding portion for holding the spring member in a resilient force accumulating state of accumulating the resilient force by the pressing portion only from start to a halfway state of the connection of the first and second housings.

According to the present disclosure, the resilient force is accumulated in the spring member held in the resilient force accumulating state from the start to the halfway state of the connection in the process of connecting the first and second housings. The both housings can be prevented from being left in an incompletely connected state by this resilient force accumulated in the spring member. If the spring member is released from the resilient force accumulating state during the connection, the first and second housings are properly connected by the resilient restoring force applied to the pressure receiving portion from the spring member. The resilient force accumulated in the spring member becomes connection resistance and increases as the connection of the both housings proceeds. Since the resilient force is accumulated in the spring member only from the start to the halfway state of the connection in the connector of the present disclosure, the connection resistance is small as compared to the case where the resilient force continues to be accumulated in the spring member from the start to the end of the connection. Therefore, the connector of the present disclosure can reduce the connection resistance while preventing the both housings from being left in the incompletely connected state.

(2) Preferably, the pressing portion and the pressure receiving portion are arranged adjacent to each other, the pressing portion has a guiding surface, and the guiding surface guides the spring member toward a resilient force releasing position for applying the resilient restoring force to the pressure receiving portion. According to this configuration, if a holding state by the holding portion is released, the spring member in the resilient force accumulating state moves to the resilient force releasing position for applying the resilient restoring force to the pressure receiving portion by the guiding action of the guiding surface. Since the pressing portion and the pressure receiving portion are arranged adjacent to each other, a movement stroke of the spring member is small and space saving can be achieved.

(3) Preferably, in (2), the spring member is constituted by a compression coil spring having an axis oriented in a direction intersecting a guiding direction by the guiding surface, and the spring member is externally fit to a shaft-like supporting member. According to this configuration, the spring member is hardly buckled and deformed to bend the axis by being externally fit to the shaft-like supporting member. Therefore, the spring member in the resilient force accumulating state can smoothly move to the resilient force releasing position for applying the resilient restoring force to the pressure receiving portion.

(4) Preferably, the connector is provided with a slider provided in the first housing, the slider being slidable in a direction intersecting a connecting direction of the first and second housings while holding the spring member, and a cam functioning portion provided in the slider and the second housing, the cam functioning portion moving the slider to a state switching position according to a connecting operation of the first and second housings, wherein the spring member in the resilient force accumulating state is switched to a resilient force releasing state of applying the resilient restoring force to the pressure receiving portion if the slider moves to the state switching position. According to this configuration, as the connection of the first and second housings proceeds, the slider moves toward the state switching position with the spring member held by the cam functioning portion. If the slider reaches the state switching position, the spring member is switched from the resilient force accumulating state to the resilient force releasing state. Since the spring member to be resiliently deformed is not displaced to the resilient force releasing state by being directly pushed, but displaced to the resilient force releasing state by being held in the slider, the buckling deformation of the spring member can be prevented.

(5) Preferably, in (4), the cam functioning portion includes a cam groove formed in the slider and a cam pin formed on the second housing, and the cam pin is formed to receive the resilient restoring force of the spring member as the spring member is switched from the resilient force accumulating state to the resilient force releasing state. According to this configuration, since the cam pin also functions as a pressure receiving portion, the shape of the second housing can be simplified as compared to the case where the second housing is formed with a dedicated pressure receiving portion separately from the cam pin.

### Details of Embodiments of Present Disclosure

[First Embodiment]

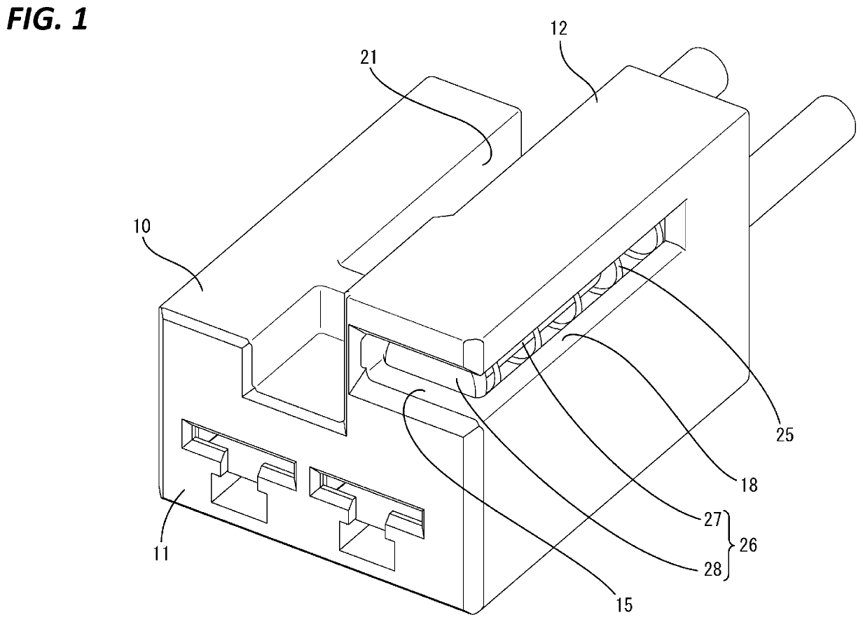

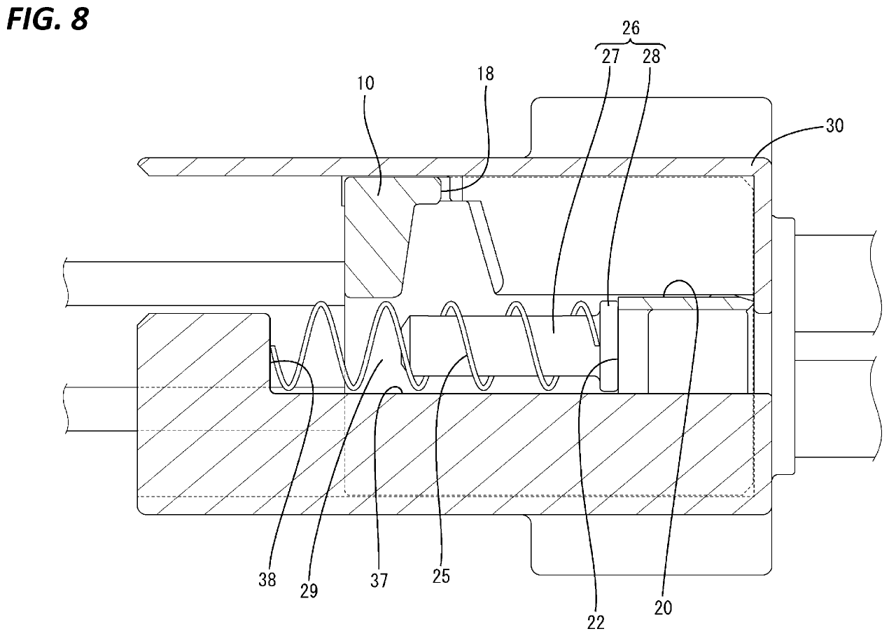

A first specific embodiment of the present disclosure is described below with reference to FIGS. 1 to 8. Note that the present invention is not limited to these illustrations and is intended to be represented by claims and include all changes in the scope of claims and in the meaning and scope of equivalents.

A connector of the first embodiment is provided with a first housing 10, a spring member 25 mounted in the first housing 10 and a second housing 30 connectable to and separable from the first housing 10. The first and second housings 10, 30 are connected by approaching each other along a front-rear direction, and separated by moving away from each other along the front-rear direction. In the first embodiment, a connecting direction and the front-rear direction are used as synonyms.

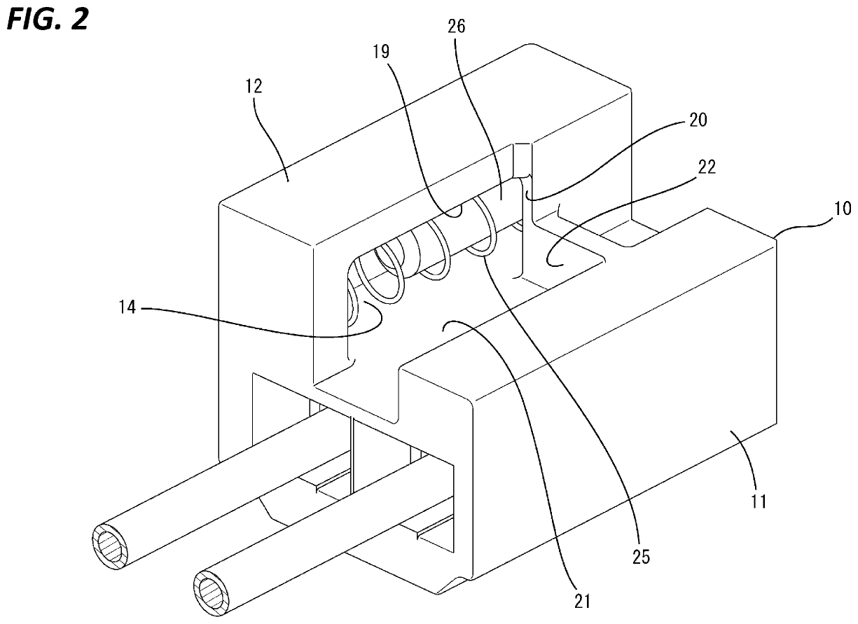

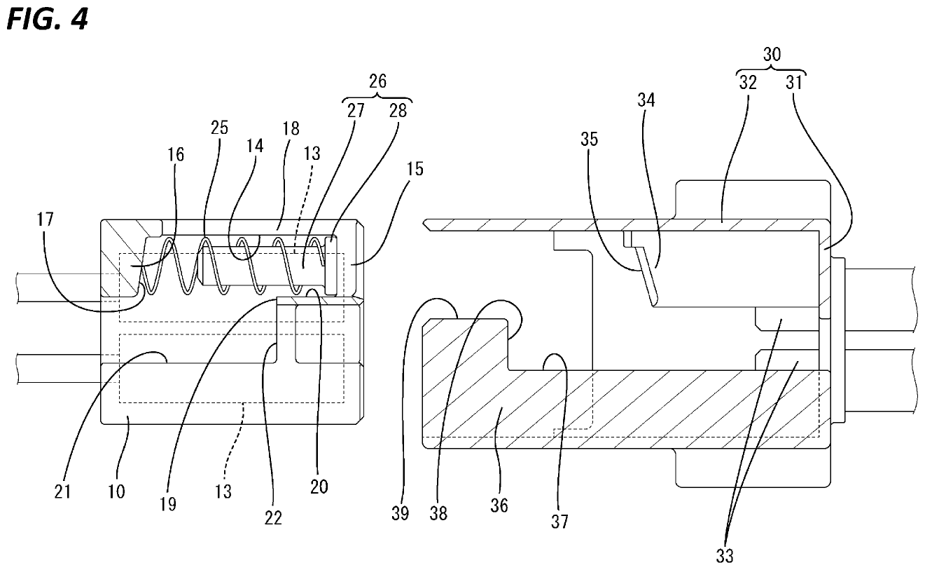

In the first embodiment, an oblique left lower side in FIG. 1, an oblique right upper side in FIG. 2 and a right side in FIGS. 4 to 8 are defined as a front side concerning the front-rear direction of the first housing 10. A left side in FIGS. 4 to 8 is defined as a front side concerning the front-rear direction of the second housing 30. Upper and lower sides shown in FIGS. 1 to 3 are directly defined as upper and lower sides concerning a vertical direction. A lower side in FIGS. 4 to 8 is defined as a right side and an upper side in FIGS. 4 to 8 is defined as a left side concerning a lateral direction.

The first housing 10 is, as shown in FIGS. 1 and 2, a single component including a housing body portion 11 and a spring accommodating portion 12 projecting upward from a left side region on the upper surface of the housing body portion 11. As shown in FIG. 4, a pair of left and right female first terminal fittings 13 are accommodated in the housing body portion 11.

A resilient force accumulation chamber 14 elongated in the front-rear direction is formed inside the spring accommodating portion 12. A stopper 15 facing the resilient force accumulation chamber 14 from front is formed in a front end part of the spring accommodating portion 12. A first pressing portion 16 facing the resilient force accumulation chamber 14 from behind is formed in a rear end part of the spring accommodating portion 12. The front surface (surface facing the resilient force accumulation chamber 14) of the first pressing portion 16 functions as a first guiding surface 17. The first guiding surface 17 is inclined to face in a direction obliquely rightward with respect to the front-rear direction.

The spring accommodating portion 12 is formed with a communication groove 18 communicating with the inside of the resilient force accumulation chamber 14 from the left outer side surface of the spring accommodating portion 12. A front end part of the communication groove 18 penetrates through the stopper 15 in the front-rear direction, thereby allowing communication between the front end surface of the spring accommodating portion 12 and the inside of the resilient force accumulation chamber 14. The spring accommodating portion 12 is formed with a communication hole 19 allowing communication between the outer side surface of the spring accommodating portion 12 and the resilient force accumulation chamber 14. An opening region in the front-rear direction of the communication hole 19 is a range from a position behind the front end of the resilient force accumulation chamber 14 to the rear end of the resilient force accumulation chamber 14. Out of an inner wall part on a right side constituting the resilient force accumulation chamber 14, a part forward of the communication hole 19 functions as a first holding portion 20.

A first recess 21 to the right of and adjacent to the spring accommodating portion 12 is formed in the upper surface of the housing body portion 11. A formation region of the first recess 21 in the front-rear direction is a range from the rear end of the first holding portion 20 to the rear end of the second housing 30. The rear end of the first recess 21 is open in the rear end surface of the first housing 10. A front surface part of the first recess 21, i.e. a rear surface part of the first holding portion 20, functions as a first pressure receiving portion 22 facing the first recess 21 from front.

The spring member 25 is constituted by a compression coil spring having an axis oriented in the front-rear direction. The spring member 25 is mounted on a shaft-like supporting member 26. The shaft-like supporting member 26 is a single component including a shaft portion 27 having an axis oriented in the front-rear direction and a diameter-expanded portion 28 formed on a front end part of the shaft portion 27. The spring member 25 is externally fit to the shaft portion 27, and the front end of the spring member 25 is in contact with the diameter-expanded portion 28 from behind. The spring member 25 and the shaft-like supporting member 26 are accommodated in the resilient force accumulation chamber 14. In the resilient force accumulation chamber 14, the spring member 25 is resiliently deformed, the rear end of the spring member 25 is in contact with the first pressing portion 16 from front and the diameter-expanded portion 28 is in contact with the stopper 15 from behind.

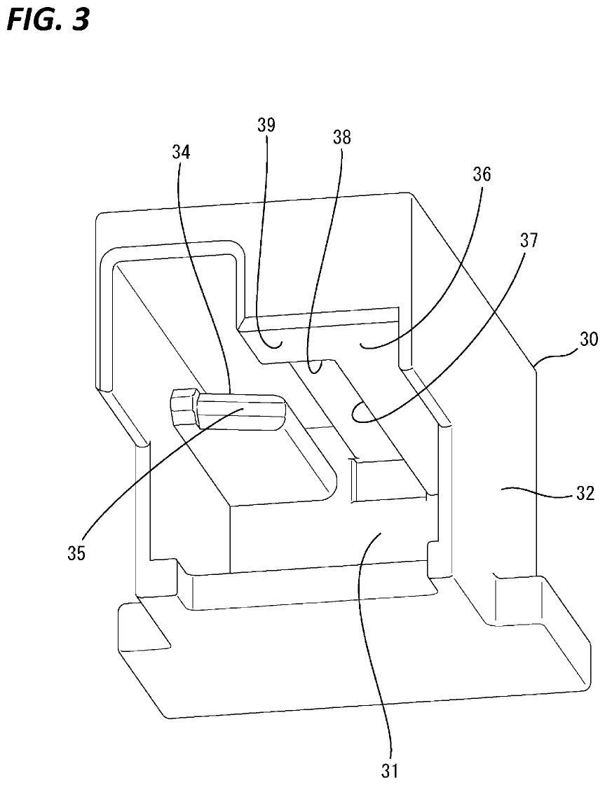

As shown in FIG. 3, the second housing 30 is a single component including a terminal supporting portion 31 and a receptacle 32 in the form of a rectangular tube projecting forward from the outer peripheral edge of the terminal supporting portion 31. As shown in FIG. 4, a pair of left and right male second terminal fittings 33 are mounted in the terminal supporting portion 31. A second pressing portion 34 in the form of a rib projecting from a left side wall part constituting the receptacle 32 is formed in the receptacle 32. A second guiding surface 35 is formed on a front end part of the second pressing portion 34. The second guiding surface 35 is located behind the front end of the receptacle 32 in the front-rear direction.

A bulging portion 36 connected to an upper wall part and the left side wall part constituting the receptacle 32 is formed in the receptacle 32. The bulging portion 36 is formed with a second recess 37 by cutting the left side surface and lower surface of the bulging portion 36. A front surface part of the second recess 37 functions as a second pressure receiving portion 38 facing the second recess 37 from front. The second pressure receiving portion 38 is located forward of the front end (second guiding surface 35) of the second pressing portion 34. A part of the bulging portion 36 forward of the front surface of the second recess 37 (rear end of the second pressure receiving portion 38) functions as a second holding portion 39.

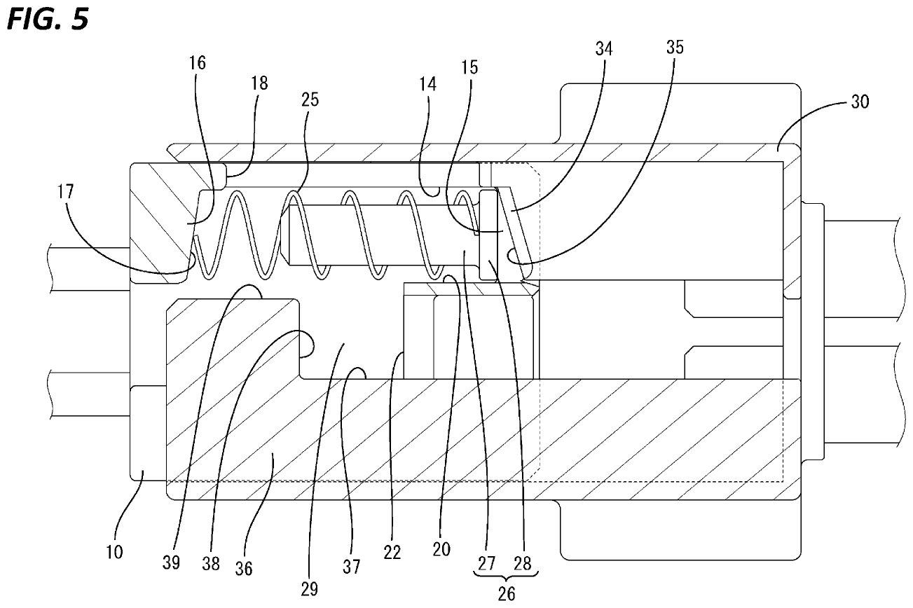

In connecting the first and second housings 10, 30, the both housings 10, 30 are brought closer to each other with the front ends of the both housings 10, 30 facing each other and the first housing 10 is inserted into the receptacle 32 as shown in FIG. 4. As insertion proceeds, the second pressing portion 34 is inserted into a front end part of the communication groove 18, the front end (second guiding surface 35) of the second pressing portion 34 comes into contact with the diameter-expanded portion 28 from front, and the bulging portion 36 covers the right side surface of the spring accommodating portion 12 and the upper surface of the housing body portion 11 as shown in FIG. 5. In the first embodiment, a timing at which the second pressing portion 34 comes into contact with the diameter-expanded portion 28 is defined as a connection start of the both housings 10, 30.

At the start of the connection, the second pressure receiving portion 38 is located to face the resilient force accumulation chamber 14 from right and a front end part of the second recess 37 communicates with a part of the first recess 21. A resilient force releasing chamber 29 is constituted by the first and second recesses 21, 37. The resilient force releasing chamber 29 is a space between the first and second pressure receiving portion 22, 38 in the front-rear direction. A front-rear length of the resilient force releasing chamber 29 at the start of the connection is shorter than that of the resilient force accumulation chamber 14.

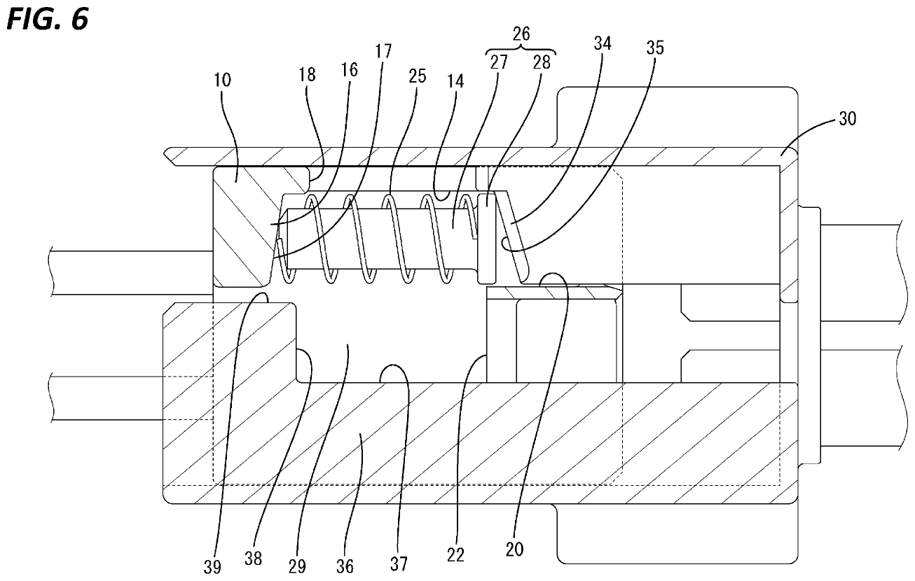

If the connection is started, the spring member 25 is sandwiched in parallel to the connecting direction between the first and second pressing portions 16, 34. If the connection of the both housings 10, 30 proceeds from this state, the first and second pressing portions 16, 34 approach each other as shown in FIG. 6, wherefore the spring member 25 sandwiched by the both pressing portions 16, 34 accumulates a resilient force. The accumulated resilient force increases as the connection of the both housings 10, 30 proceeds. Since the second pressing portion 34 is facing the first pressing portion 16 from the side of the second housing 30, the resilient force accumulated in the spring member 25 becomes connection resistance against a connecting operation of the both housings 10, 30.

The resilient force accumulated in the spring member 25 acts as a reaction force against the first and second guiding surfaces 17, 35. The both guiding surfaces 17, 35 are inclined in directions to push the spring member 25 in the resilient force accumulation chamber 14 toward a side to the right of the resilient force accumulation chamber 14, i.e. toward the resilient force releasing chamber 29 (first and second recesses 21, 37). However, the first holding portion 20 is located to face the spring member 25 from right in a front end part of the resilient force accumulation chamber 14, and the second holding portion 39 is located to face the spring member 25 from right in a rear end part of the resilient force accumulation chamber 14. Therefore, the spring member 25 remains to be accommodated in the resilient force accumulation chamber 14 and is held in a resilient force accumulating state of accumulating the resilient force as the connection of the both housings 10, 30 proceeds.

As the connection of the both housings 10, 30 proceeds, the second pressing portion 34 enters the resilient force accumulation chamber 14 as shown in FIG. 6, whereby the diameter-expanded portion 28 and the front end of the spring member 25 are relatively displaced rearward with respect to the first holding portion 20. Simultaneously, the second holding portion 39 is relatively displaced rearward with respect to the spring member 25. As the connection of the both housings 10, 30 further proceeds, the second holding portion 39 reaches the same position as the rear end of the spring member 25 at the same time as the diameter-expanded portion 28 reaches the same position as the rear end of the first holding portion 20. By this positional relationship, the first and second holding portions 20, 39 release the state where the spring member 25 is held in the resilient force accumulating state.

If the connecting operation is finished while the spring member 25 is held in the resilient force accumulating state by the both holding portions 20, 39, the resilient force accumulated in the spring member 25 acts on the both pressing portions 16, 34. Thus, the both housings 10, 30 are separated by the resilient force of the spring member 25. Therefore, the both housings 10, 30 are not left in the incompletely connected state without reaching a properly connected state.

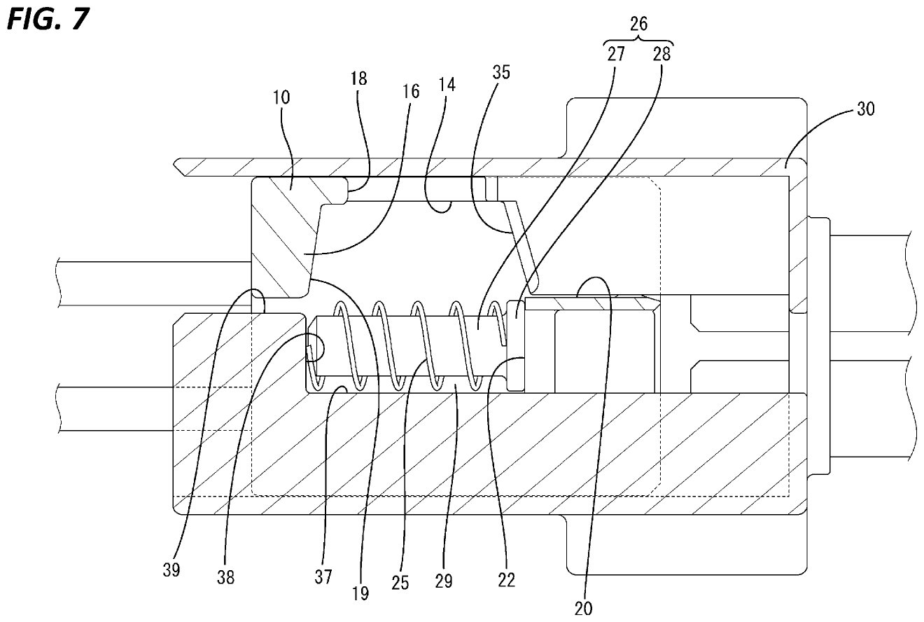

When the holding by the both holding portions 20, 39 is released, the second pressure receiving portion 38 reaches the same position as the first pressing portion 16 in the front-rear direction and the second pressing portion 34 reaches the same position as the first pressure receiving portion 22 in the front-rear direction. Then, the spring member 25 and the shaft-like supporting member 26 are pushed from the resilient force accumulation chamber 14 to the resilient force releasing chamber 29 as shown in FIG. 7 by the resilient force accumulated in the spring member 25 and the inclination of the first and second guiding surfaces 17, 35.

If the spring member 25 moves to the resilient force releasing chamber 29, the resilient force accumulated in the spring member 25 acts as a resilient restoring force on the first and second pressure receiving portions 22, 38. That is, the spring member 25 moves from the resilient force accumulation chamber 14 to the resilient force releasing chamber 29 while the both housings 10, 30 are being connected, whereby the spring member 25 is switched from the resilient force accumulating state of accumulating the resilient force by the both pressing portions 16, 34 to a resilient force releasing state of applying the accumulated resilient force to the both pressure receiving portions 22, 38.

In the resilient force releasing chamber 29, the second pressure receiving portion 38 formed in the second housing 30 is located to face the first pressure receiving portion 22 from the side of the first housing 10. A facing direction of the second pressure receiving portion 38 facing the first pressure receiving portion 22 and that of the first pressing portion 34 facing the first pressing portion 16 are opposite along the front-rear direction. Thus, the resilient restoring force acting on the both pressure receiving portions 22, 38 from the spring member 25 acts as a force in a direction to connect the both housings 10, 30. Therefore, the both housings 10, 30 are not left in the incompletely connected state and reliably reach a connection completed state (properly connected state).

The connector of the first embodiment is provided with the first housing 10, the second housing 30 connectable to and separable from the first housing 10 and the spring member 25. The first housing 10 is formed with the first pressing portion 16, the first pressure receiving portion 22 and the first holding portion 20. The second housing 30 is formed with the second pressing portion 34, the second pressure receiving portion 38 and the second holding portion 39. The first and second pressing portions 16, 34 are arranged in such a positional relationship as to accumulate the resilient force in the spring member 25 according to the connection of the both housings 10, 30. The first and second holding portions 20, 39 hold the spring member 25 in the resilient force accumulating state of accumulating the resilient force by the both pressing portions 16, 34 only from the start to a halfway state of the connection of the both housings 10, 30. The first and second pressure receiving portions 22, 38 are arranged to receive the resilient restoring force in the direction to connect the both housings 10, 30 from the spring member 25 having the resilient force accumulated therein.

In the process of connecting the first and second housings 10, 30, the resilient force is accumulated in the spring member 25 by the both pressing portions 16, 34 from the start to the halfway state of the connection, i.e. while the spring member 25 is held in the resilient force accumulating state by the both holding portions 20, 39. If the connecting operation is finished while the resilient force is being accumulated in the spring member 25, the both housings 10, 30 are separated by the resilient force accumulated in the spring 25, wherefore the both housings 10, 30 can be prevented from being left in the incompletely connected state. If the holding state by the both holding portions 20, 39 is released and the spring member 25 is released from the resilient force accumulating state while the both housings 10, 30 are being connected, the first and second housings 10, 30 are properly connected by the resilient restoring force applied to the both pressure receiving portions 22, 38 from the spring member 25 having the resilient force accumulated therein, and the connection is completed. Therefore, also after the holding by the both holding portions 20, 39 is released, the both housings 10, 30 are not left in the incompletely connected state.

In the process of connecting the both housings 10, 30, the resilient force accumulated in the spring member 25 increases as the connection of the both housings 10, 30 proceeds. The resilient force accumulated in the spring member 25 becomes connection resistance against a connecting force applied to the both housings 10, 30. In the connector of the first embodiment, the resilient force is accumulated in the spring member 25 only from the start to the halfway state of the connection. Accordingly, the connector of the first embodiment has small connection resistance as compared to the case where the resilient force continues to be accumulated in the spring member 25 from the start to the end of the connection of the both housings 10, 30. Thus, according to the connector of the first embodiment, the connection resistance can be reduced while the both housings 10, 30 are prevented from being left in the incompletely connected state.

In the process of connecting the both housings 10, 30, the both pressing portions 16, 34 and the both pressure receiving portions 22, 38 are arranged laterally adjacent to each other. The first and second pressing portions 16, 34 have the first and second guiding surfaces 17, 35. The first and second guiding surfaces 17, 35 guide the spring member 25 toward a resilient force releasing position where the resilient restoring force is applied to the both pressure receiving portions 22, 38. If the holding state by the both holding portions 20, 39 is released, the spring member 25 in the resilient force accumulating state moves to the resilient force releasing position where the resilient restoring force is applied to the both pressure receiving portions 22, 38 by the guiding action of the both guiding surfaces 17, 35. Since the both pressing portions 16, 34 and the both pressure receiving portions 22, 38 are arranged laterally adjacent to each other, a movement stroke of the spring member 25 is small and space saving can be achieved.

The spring member 25 is constituted by the compression coil spring having the axis oriented in the front-rear direction intersecting a guiding direction (lateral direction) by the both guiding surfaces 17, 35. The spring member 25 is externally fit to the shaft-like supporting member 26. The spring member 25 is hardly buckled and deformed to bend the axis by being externally fit to the shaft-like supporting member 26. Therefore, the spring member 25 in the resilient force accumulating state can smoothly move to the resilient force releasing position where the resilient restoring force is applied to the both pressure receiving portions 22, 38.

[Second Embodiment]

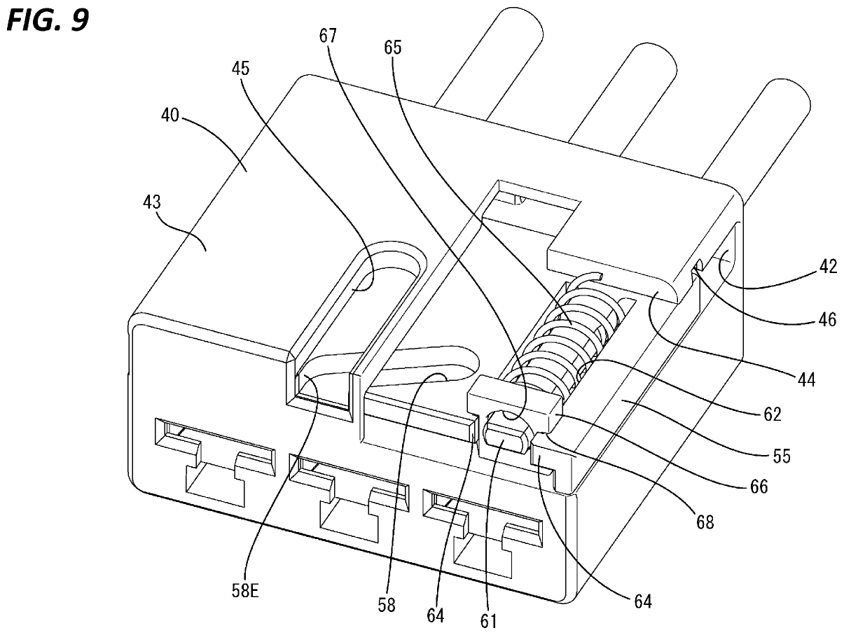

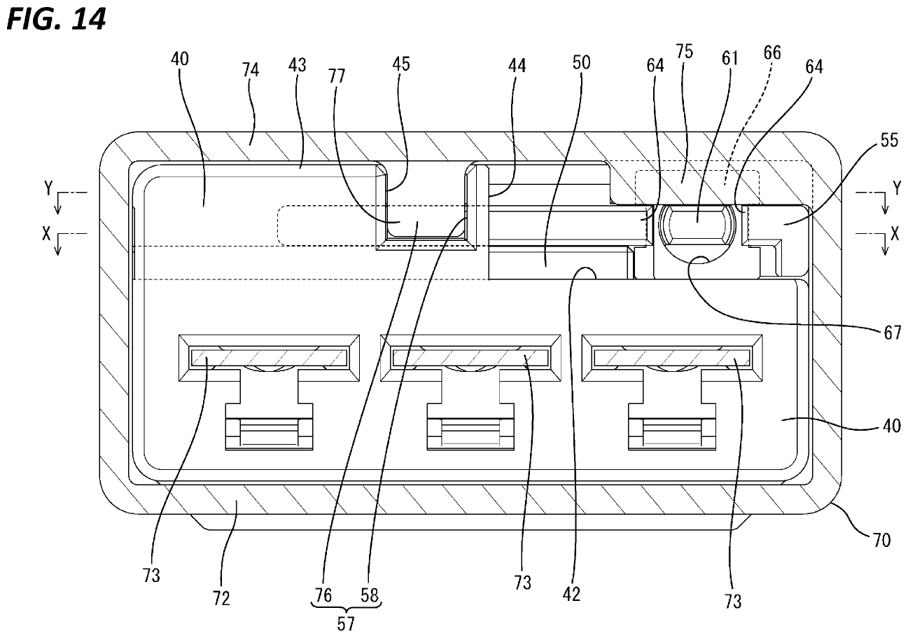

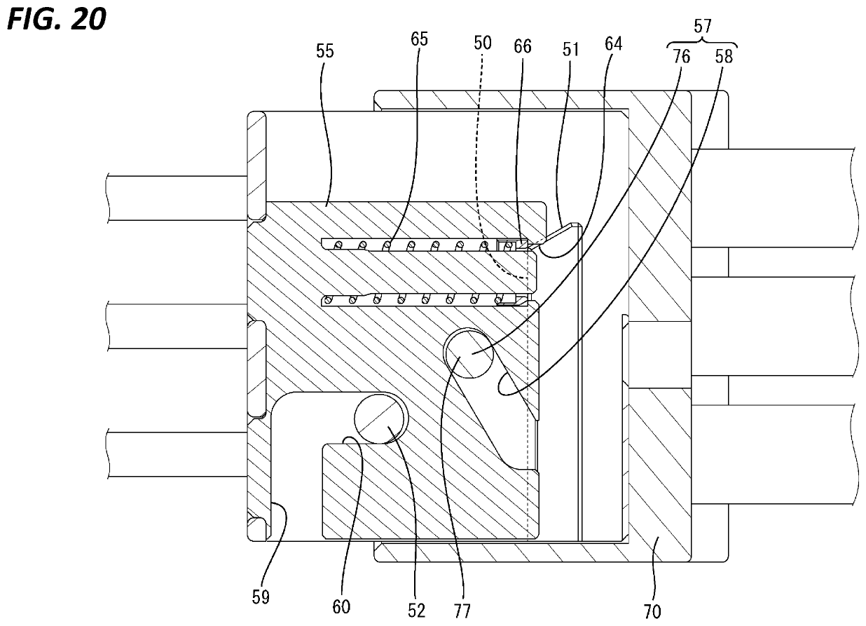

A second specific embodiment of the present disclosure is described with reference to FIGS. 9 to 20. Note that the present invention is not limited to these illustrations and is intended to be represented by claims and include all changes in the scope of claims and in the meaning and scope of equivalents.

A connector of the second embodiment is provided with a first housing 40, a slider 55 provided in the first housing 40, a spring member 65 mounted in the slider 55 and a second housing 70 connectable to and separable from the first housing 40. The first and second housings 40, 70 are connected by approaching each other along a front-rear direction, and separated by moving away from each other along the front-rear direction. In the second embodiment, a connecting direction and the front-rear direction are parallel directions.

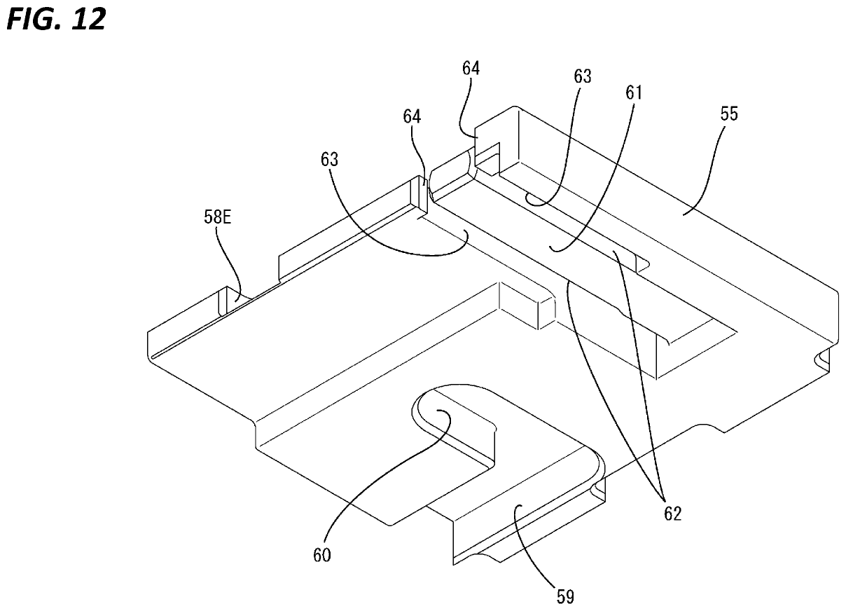

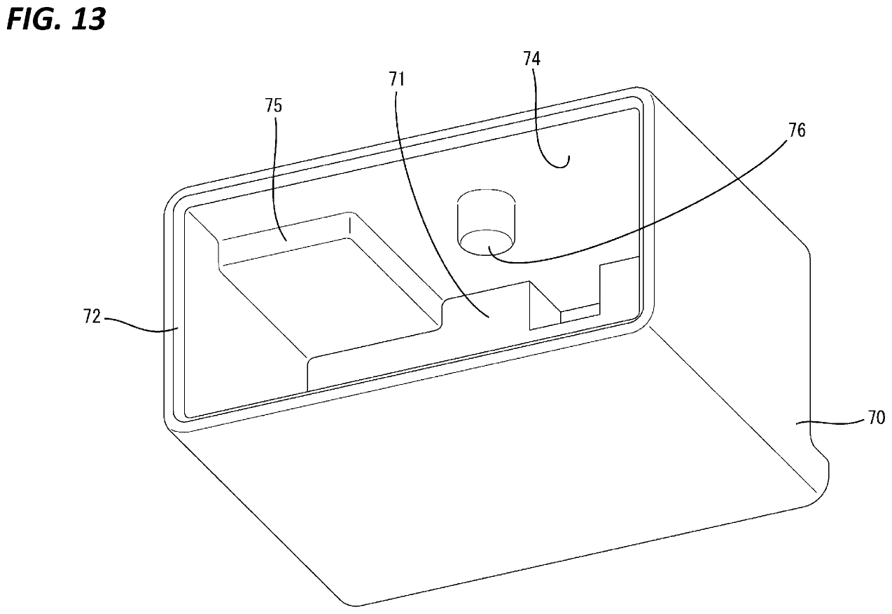

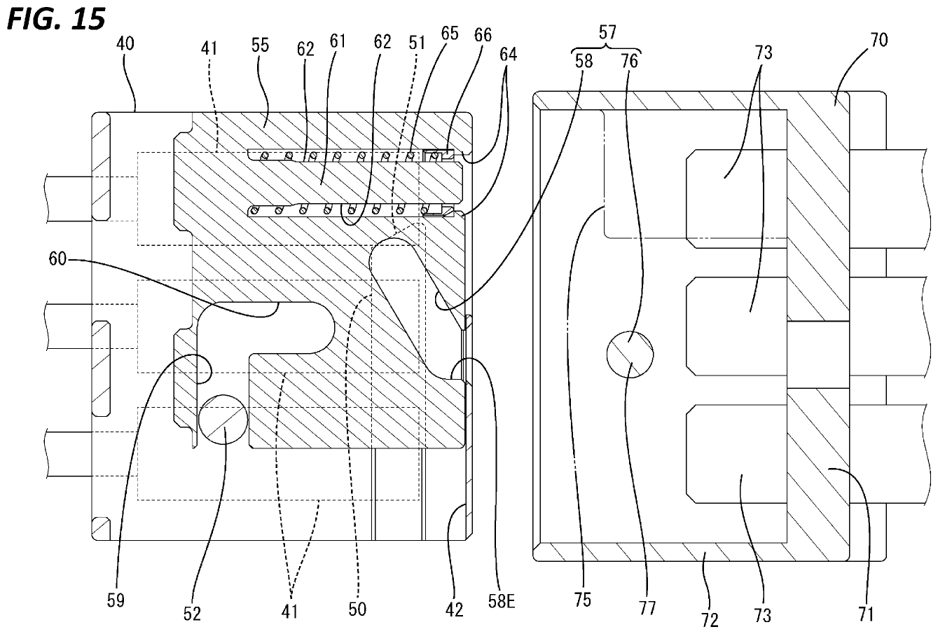

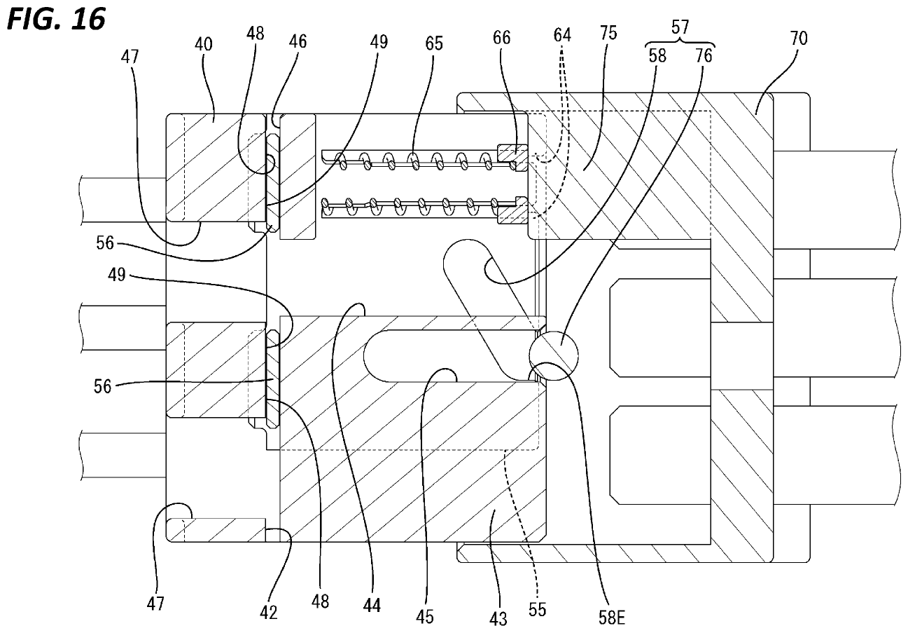

In the second embodiment, an oblique left lower side in FIGS. 9 to 11, an oblique left upper side in FIG. 12 and a right side in FIGS. 16 to 20 are defined as a front side concerning the front-rear direction of the first housing 40 and the slider 55. An oblique left upper side in FIG. 13 and a left side in FIGS. 15 to 20 are defined as a front side concerning the front-rear direction of the second housing 70. Upper and lower sides shown in FIGS. 9 to 14 are directly defined as upper and lower sides concerning a vertical direction. A lower side in FIGS. 15 to 20 is defined as a right side and an upper side in FIGS. 15 to 20 is defined as a left side concerning a lateral direction.

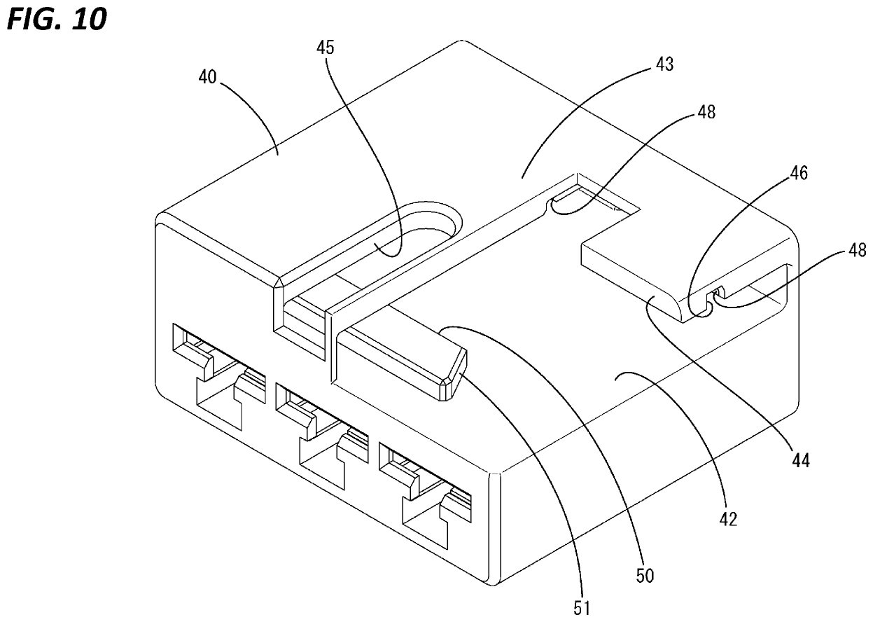

As shown in FIGS. 9 and 10, the first housing 40 has a rectangular parallelepiped shape having a small height as a whole. As shown in FIG. 15, three female first terminal fittings 41 are accommodated laterally side by side inside a lower end side of the first housing 40. As shown in FIGS. 9 and 10, a part of the first housing 40 above the first terminal fittings 41 is formed with a working chamber 42. As shown in FIG. 15, the working chamber 42 is formed to penetrate through the first housing 40 in the lateral direction. Both left and right ends of the working chamber 42 are in the form of grooves elongated in the front-rear direction and open in both left and right outer side surfaces of the first housing 40. A left region of the front end of the working chamber 42 is open in the front end part of the first housing 40.

The first housing 40 includes an upper wall portion 43 defining an upper surface part of the working chamber 42. A cut portion 44 for allowing the working chamber 42 to be open to an upper outer side of the first housing 40 is formed in a front end side region of a left part of the upper wall portion 43. An escape groove 45 elongated in the front-rear direction and open in the front end surface of the first housing 40 is formed in a part of the upper wall portion 43 to the right of the cut portion 44.

As shown in FIGS. 9, 10 and 16, a first guide groove 46 extending in the lateral direction is formed over an entire region in the lateral direction of the upper wall portion 43 in the lower surface (surface facing the working chamber 42) of the upper wall portion 43. A pair of left and right second guide grooves 47 extending in the front-rear direction from the first guide groove 46 to the rear end edge of the upper wall portion 43 are formed in the lower surface of the upper wall portion 43. The rear inner surface of the first guide groove 46 is divided into three regions by the pair of second guide grooves 47. Out of the divided three regions, two regions on left and middle sides function as a pair of holding portions 48 arranged laterally side by side. Both of the pair of holding portions 48 also function as first pressing portions 49.

As shown in FIGS. 10 and 15, a first pressure receiving portion 50 extending in the lateral direction is formed on the inner bottom surface of the working chamber 42. The first pressure receiving portion 50 is in the form of a projecting rib elongated in the lateral direction. The first pressure receiving portion 50 is formed from the right end of the working chamber 42 to a position to the right of the left end of the working chamber 42. The left end surface of the first pressure receiving portion 50 serves as a tapered guide surface 51 oblique to the front-rear direction and lateral direction. The first pressure receiving portion 50 is arranged forward of the holding portions 48 (first pressing portions 49) in the front-rear direction.

As shown in FIG. 15, a guide pin 52 is formed on the inner bottom surface of the working chamber 42. The guide pin 52 has a cylindrical shape short in height and having an axis oriented in the vertical direction. The guide pin 52 is arranged at a position forward of the holding portions 48 (first pressing portions 49) and to the right of the escape groove 45.

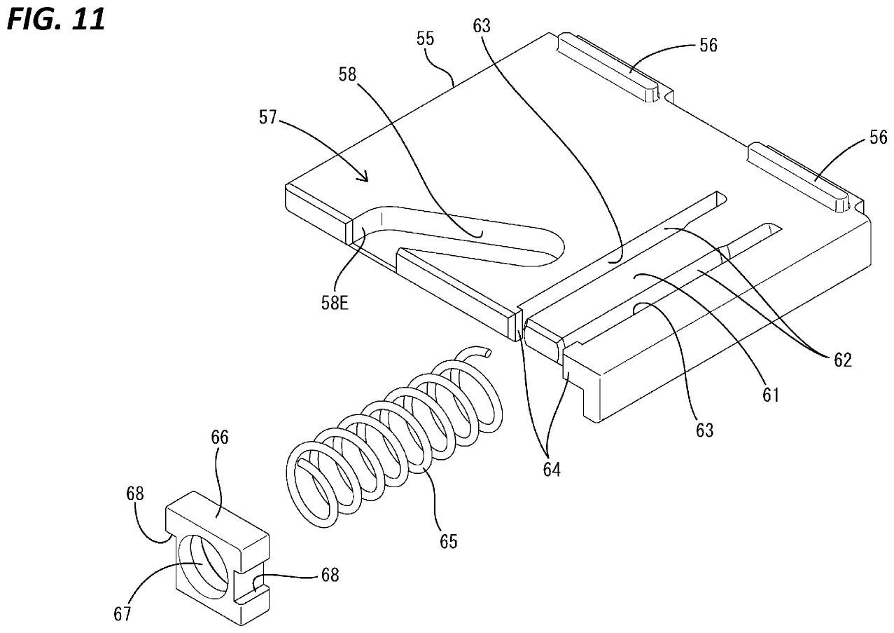

As shown in FIGS. 11 and 12, the slider 55 is in the form of a flat plate having a plate thickness direction oriented in the vertical direction as a whole. A pair of guide ribs 56 spaced apart in the lateral direction are formed in a rear end part of the upper surface of the slider 55. The guide rib 56 is elongated in the lateral direction. The rear surface of the guide rib 56 can come into contact with the holding portion 48 from front and slide in contact with the holding portion 48. A cam groove 58 constituting a cam functioning portion 57 is formed in the upper surface of the slider 55. The cam groove 58 extends obliquely to a left rear side from an entrance 58E open in the front end edge of the slider 55. A length direction of the cam groove 58 is a direction oblique to the front-rear direction and lateral direction.

As shown in FIGS. 12 and 15, a third guide groove 59 and a fourth guide groove 60 are formed in the lower surface of the slider 55. The third guide groove 59 extends in the lateral direction in a rear end part of the slider 55. The right end of the third guide groove 59 is open in the right side surface of the slider 55. The fourth guide groove 60 extends in the front-rear direction and communicates with the left end of the third guide groove 59. The fourth guide groove 60 extends forward from the third guide groove 59. The third and fourth guide grooves 59, 60 form an L shape.

As shown in FIGS. 11 and 12, the slider 55 is formed with a spring supporting portion 61. The spring supporting portion 61 is arranged to the left of the cam groove 58. The spring supporting portion 61 is in the form of a rectangular column cantilevered forward. The front end of the spring supporting portion 61 is located at the front end of the slider 55 in the front-rear direction. The slider 55 is formed with a pair of left and right slits 62 elongated in the front-rear direction. The pair of slits 62 vertically penetrate through the slider 55 and the front ends thereof are open in the front end edge of the slider 55. The slits 62 are defined by the spring supporting portion 61 and a pair of facing portions 63 facing the spring supporting portion 61 from both left and right sides. Stoppers 64 projecting into the slits 62 are formed on front end parts of the pair of facing portions 63.

The slider 55 is mounted in the first housing 40 with the slider 55 inserted in the working chamber 42 from a left side of the first housing 40 and the guide ribs 56 inserted in the first guide groove 46. In a state where the both housings 40, 70 are not connected yet, the slider 55 is positioned at an initial position as shown in FIGS. 15 and 16. With the slider 55 located at the initial position, the entrance 58E of the cam groove 58 is arranged at the same position as the escape groove 45 in the lateral direction and the guide pin 52 is accommodated in a right end part of the third guide groove 59. The guide ribs 56 are arranged at positions to the left of the second guide grooves 47. The guide ribs 56 are in contact with the holding portions 48 (first pressing portions 49) of the first guide groove 46. The spring supporting portion 61 is arranged to the left of the left end of the first pressure receiving portion 50.

As shown in FIG. 11, the spring member 65 is constituted by a compression coil spring having an axis oriented in the front-rear direction. A receiving member 66 is mounted on a front end part of the spring member 65. The receiving member 66 covers the spring member 65 from front. The receiving member 66 is formed with a through hole 67 through which the spring supporting portion 61 can be passed. A pair of asymmetrical sliding contact recesses 68 configured to slide in contact with the facing portions 63 are formed in both left and right outer side surfaces of the receiving member 66.

The spring member 65 is externally fit to the spring supporting portion 61 and mounted on the slider 55 while being resiliently deformed to contract in the front-rear direction (axial direction). The receiving member 66 is mounted in the slider 55 with both left and right side parts accommodated in the pair of slits 62 and the sliding contact recesses 68 fit to the facing portions 63. The rear end of the spring member 65 is resiliently in contact with rear end parts of the slits 62 from front. The front end of the spring member 65 is in contact with the rear surface of the receiving member 66. The front surface of the receiving member 66 is resiliently in contact with the stoppers 64 from behind.

As shown in FIG. 13, the second housing 70 is a single component including a terminal supporting portion 71 and a receptacle 72 in the form of a rectangular tube projecting forward from the outer peripheral edge of the terminal supporting portion 71. As shown in FIG. 15, three male second terminal fittings 73 are mounted in the terminal supporting portion 71. A second pressing portion 75 projecting downward is formed on the lower surface of an upper surface wall 74 constituting the receptacle 72. The second pressing portion 75 is arranged in a left end part of the receptacle 72. The front end of the second pressing portion 75 is located rearward of the front end of the receptacle 72.

A cam pin 76 projecting downward is formed on the lower surface of the upper surface wall 74. The cam pin 76 has a cylindrical shape having an axis oriented in the vertical direction. The cam pin 76 is arranged at the same position as the front end of the second pressing portion 75 in the front-rear direction. The cam pin 76 is arranged to the right of the second pressing portion 75 in the lateral direction. The cam pin 76 constitutes the cam functioning portion 57, similarly to the cam groove 58.

In connecting the first and second housings 40, 70, the both housings 40, 70 are brought closer to each other with the front ends of the both housings 40, 70 facing each other as shown in FIG. 15, and the first housing 40 is inserted into the receptacle 72. As the insertion of the first housing 40 proceeds, the second pressing portion 75 comes into contact with an upper end part of the front surface of the receiving member 66 and, as shown in FIG. 16, the cam pin 76 enters the entrance 58E of the cam groove 58 and a front end part of the escape groove 45. In the second embodiment, a timing at which the second pressing portion 75 comes into contact with the receiving member 66 is defined as a connection start of the both housings 40, 70.

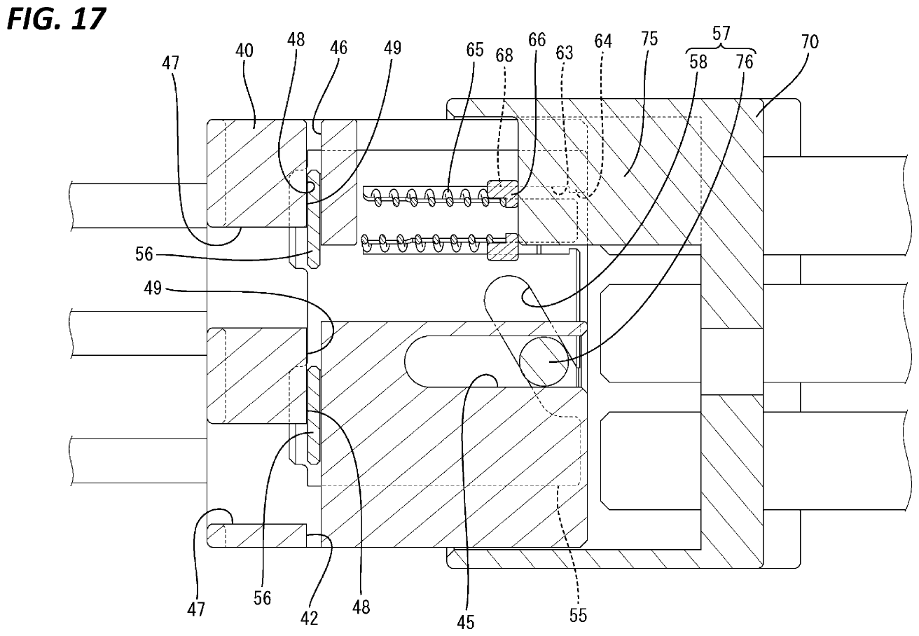

If the connection of the both housings 40, 70 proceeds after the start of the connection, the second pressing portion 75 approaches the first pressing portion 49 from the front of the first housing 40 while entering the working chamber 42 and pushing the receiving member 66 rearward as shown in FIG. 17. A pressing force applied to the receiving member 66 from the second pressing portion 75 is applied to the slider 55 via the spring member 65. However, since the guide ribs 56 of the slider 55 are in contact with the first pressing portions 49, the slider 55 cannot be relatively displaced rearward with respect to the first housing 40. Accordingly, the spring member 65 is sandwiched between the first and second pressing portions 49, 75 via the slider 55 and a resilient force is accumulated in the spring member 65. A state where the spring member 65 is sandwiched between the both pressing portions 49 and 75 to accumulate the resilient force is defined as a resilient force accumulating state. The resilient force accumulated in the spring member 65 increases as the connection of the both housings 40, 70 proceeds. Since the second pressing portion 75 is facing the first pressing portion 49 from the side of the second housing 70, the resilient force accumulated in the spring member 65 becomes connection resistance against a connecting operation of the both housings 40, 70.

As the connection of the both housings 40, 70 proceeds, the cam pin 76 and the cam groove 58 exhibit a cam function by the cam pin 76 sliding in contact along an inclined surface of the cam groove 58. By this cam function, the slider 55 slides rightward, i.e. in a direction orthogonal to a connecting direction of the both housings 40, 70 while the guide ribs 56 are slid in contact with the first guide groove 46. The spring member 65 and the receiving member 66 also slide rightward together with the slider 55. However, since the front surface of the second pressing portion 75 extends long in the lateral direction, the receiving member 66 is not disengaged from the second pressing portion 75. Further, since the guide ribs 56 and the first guide groove 46 also extend in the lateral direction, the guide ribs 56 are not disengaged from the first guide groove 46. Therefore, the spring member 65 is held in the resilient force accumulating state of accumulating the resilient force as the connection of the both housings 40, 70 proceeds.

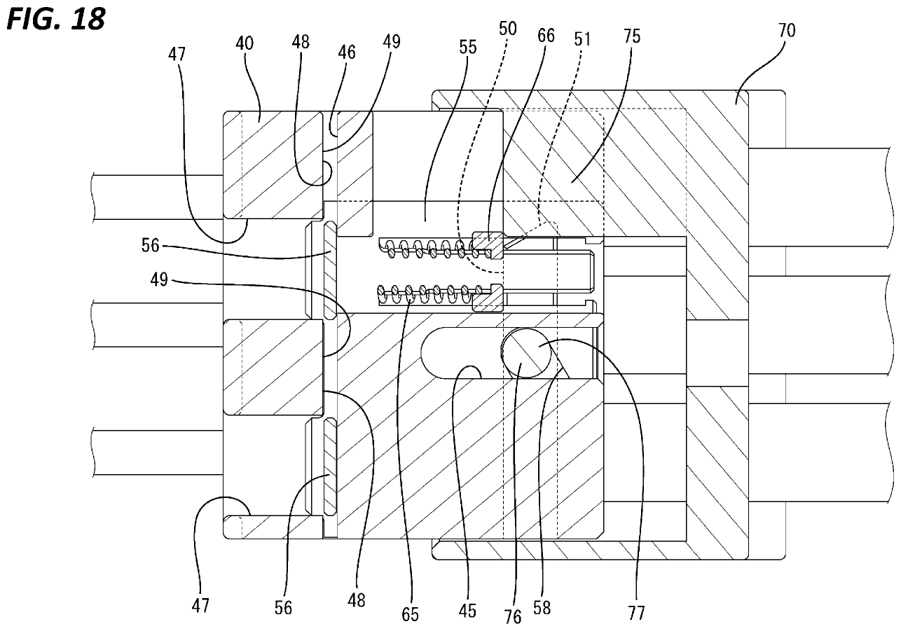

If the both housings 40, 70 are further connected and the slider 55 slides further rightward, the entire guide ribs 56 are disengaged rightward from the holding portions 48 and the slider 55 is in a state relatively displaceable rearward with respect to the first housing 40 as shown in FIG. 18. In other words, the holding portions 48 release a state where the spring member 65 is held in the resilient force accumulating state. In the second embodiment, the position of the slider 55 at this time is defined as a state switching position.

The guide pin 52 slides in contact with the third guide groove 59 while the slider 55 is sliding to the state switching position. When the slider 55 reaches the state switching position, the guide pin 52 reaches the left end of the third guide groove 59 (i.e. the rear end of the fourth guide groove 60). When the slider 55 reaches the state switching position, the cam pin 76 reaches a rear end part (rear end) of the cam groove 58.

Further, the disengagement of the guide ribs 56 from the holding portions 48 means that the resilient force accumulated in the spring member 65 is no longer transmitted to the first pressing portion 49. At the same time as the slider 55 reaches the state switching position, the receiving member 66 is disengaged rightward from the second pressing portion 75. Accordingly, the spring member 65 is released from the resilient force accumulating state of accumulating the resilient force by the first and second pressing portions 49, 75 and is switched to a resilient force releasing state where the accumulated resilient force can be released. That is, the spring member 65 continues to be held in the resilient force accumulating state by the holding portions 48 until the slider 55 reaches the state switching position after the start of the connection of the both housings 40, 70. When the slider 55 reaches the state switching position, the spring member 65 is switched from the resilient force accumulating state to the resilient force releasing state.

If the connecting operation is finished while the spring member 65 is held in the resilient force accumulating state, the resilient force accommodated in the spring member 65 acts on the first and second pressing portions 49, 75 via the slider 55 and the receiving member 66. Thus, the both housings 40, 70 are separated by the resilient force of the spring member 65. Therefore, the both housings 40, 70 are not left in an incompletely connected state without reaching a properly connected state.

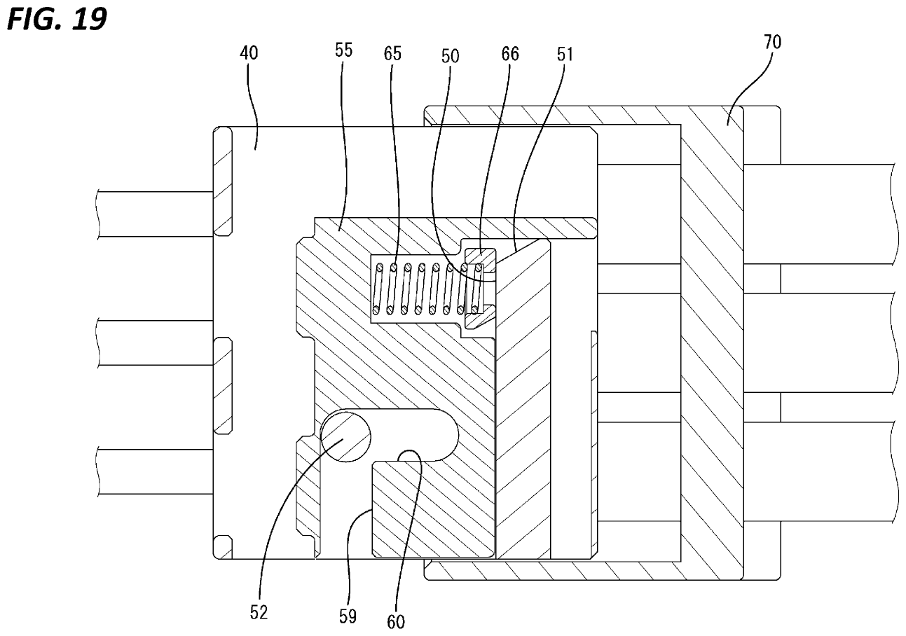

If the slider 55 reaches the state switching position and the spring member 65 is switched from the resilient force accumulating state to the resilient force releasing state, the spring member 65 reaches the same position as a left end part of the first pressing portion 50 in the lateral direction and, as shown in FIG. 19, a lower end part of the receiving member 66 comes into contact with the first pressing portion 50 from behind. Therefore, the resilient force accumulated in the spring member 65 is applied to the first pressing portion 50 from behind. Further, if the guide ribs 56 are disengaged from the holding portions 48, the resilient force acting on the slider 55 from the rear end of the spring member 65 is applied to the cam pin 76 from the cam groove 58. At this point of time, the cam pin 76 is switched to a functional part serving as the second pressing portion 77 of the second housing 70 and the resilient force of the spring member 65 acts on the second pressing portion 77 from front via the slider 55.

If the spring member 65 is switched to the resilient force releasing state, the resilient force accumulated in the spring member 65 acts as a resilient restoring force on the first and second pressure receiving portions 50, 77. A pushing direction of the first pressure receiving portion 50 of the first housing 40 by the resilient force of the spring member 65 is the same direction as the connecting direction of the first housing 40 to the second housing 70. A pushing direction of the second pressure receiving portion 77 of the second housing 70 by the resilient force of the spring member 65 is the same direction as the connecting direction of the second housing 70 to the first housing 40. That is, the resilient restoring force acting on the both pressure receiving portions 50, 77 from the spring member 65 acts as a force in a direction to connect the both housings 40, 70. Therefore, if the spring member 65 is switched to the resilient force releasing state, the both housings 40, 70 reliably reach a connection completed state (properly connected state) without being left in the incompletely connected state by the resilient force (resilient force) accommodated in the spring member 65.

The connector of the second embodiment is provided with the first housing 40, the second housing 70 connectable and connectable to and separable from the first housing 40 and the spring member 65. The first housing 40 is formed with the first pressing portion 49, the first pressure receiving portion 50 and the holding portion 48. The second housing 70 is formed with the second pressing portion 75 and the second pressure receiving portion 77. The first and second pressing portions 49, 75 are arranged in such a positional relationship to accumulate the resilient force in the spring member 65 according to the connection of the both housings 40, 70. The holding portion 48 holds the spring member 65 in the resilient force accumulating state of accumulating the resilient force by the both pressing portions 49, 75 only from the start to a halfway state of the connection of the both housings 40, 70. The first and second pressure receiving portions 50, 77 are arranged to receive the resilient restoring force in the direction to connect the both housings 40, 70 from the spring member 65 having the resilient force accumulated therein.

In the process of connecting the first and second housings 40, 70, the resilient force is accumulated in the spring member 65 by the both pressing portions 49, 75 from the start to the halfway state of the connection, i.e. while the spring member 65 is held in the resilient force accumulating state by the holding portion 48. If the connecting operation is finished while the resilient force is accumulated in the spring member 65, the both housings 40, 70 are separated by the resilient force accumulated in the spring 65, wherefore the both housings 40, 70 can be prevented from being left in the incompletely connected state. If the holding state by the holding portion 48 is released and the spring member 65 is released from the resilient force accumulating state while the both housings 40, 70 are being connected, the first and second housings 40, 70 are properly connected by the resilient restoring force applied to the both pressure receiving portions 50, 77 from the spring member 65 having the resilient force accumulated therein, and the connection is completed. Therefore, also after the holding by the holding portion 48 is released, the both housings 40, 70 are not left in the incompletely connected state.

In the process of connecting the both housings 40, 70, the resilient force accumulated in the spring member 65 increases as the connection of the both housings 40, 70 proceeds. The resilient force accumulated in the spring member 65 becomes connection resistance against a connecting force applied to the both housings 40, 70. In the connector of the second embodiment, the resilient force is accumulated in the spring member 65 only from the start to the halfway state of the connection. Accordingly, the connector of the second embodiment has small connection resistance as compared to the case where the resilient force continues to be accumulated in the spring member 65 from the start to the end of the connection of the both housings 40, 70. Thus, according to the connector of the second embodiment, the connection resistance can be reduced while the both housings 40, 70 are prevented from being left in the incompletely connected state.

The first housing 40 is provided with the slider 55. The slider 55 is slidable in the direction intersecting the connecting direction of the first and second housings 40, 70 while holding the spring member 65. The slider 55 is provided with the cam groove 58 serving as the cam functioning portion 57, and the second housing 70 is provided with the cam pin 76 serving as the cam functioning portion 57. The cam groove 58 and the cam pin 76 move the slider 55 to the state switching position according to the connecting operation of the both housings 40, 70. The state switching position is a position where the spring member 65 in the resilient force accumulating state is switched to the resilient force releasing state of applying the resilient restoring force to the both pressure receiving portions 50, 77.

According to this configuration, as the connection of the both housings 40, 70 proceeds, the slider 55 moves to the start switching position with the spring member 65 held by the cam functioning portion 57 and the spring member 65 is switched from the resilient force accumulating state to the resilient force releasing state. The spring member 65 to be resiliently deformed is not displaced to the resilient force releasing state by being directly pushed, but is displaced to the resilient force releasing state by being held in the slider 55. Thus, the buckling deformation of the spring member 65 can be prevented.

The cam pin 76 is formed to receive the resilient restoring force of the spring member 65 as the spring member 65 is switched from the resilient force accumulating state to the resilient force releasing state. That is, the cam pin 76 also functions as the second pressure receiving portion 77. Therefore, the shape of the second housing 70 can be simplified as compared to the case where the second housing 70 is provided with a dedicated pressure receiving portion separately from the cam pin 76.

[Other Embodiments]

The present invention is not limited by the above described and illustrated embodiments, but is represented by claims. The present invention is intended to include all changes in the scope of claims and in the meaning and scope of equivalents and also include the following embodiments.

Although the spring member is externally fit to the shaft-like member in the above first embodiment, the shaft-like member may not be provided.

Although the guiding surfaces are formed on the first pressing portion of the first housing and the second pressing portion of the second housing in the above first embodiment, the guiding surface may be formed only on the first pressing portion or only on the second pressing portion.

Although the cam pin of the second housing also functions as the second pressure receiving portion in the above second embodiment, a dedicated second pressure receiving portion may be formed separately from the cam pin.

Although the slider moves in the direction orthogonal to the connecting direction of the both housings in the above second embodiment, the moving direction of the slider may be a direction oblique to the connecting direction of the both housings.

Although the slider is formed with the cam groove and the second housing is formed with the cam pin in the above second embodiment, the slider may be formed with a cam pin and the second housing may be formed with a cam groove.

Although the buckling of the spring member is prevented by externally fitting the spring member to the shaft-like portion of the slider in the above second embodiment, the buckling of the spring member may be prevented by surrounding the outer periphery of the spring member by a wall-like portion or the like.

Although the compression coil spring is used as the spring member in the above first and second embodiments, the spring member may be a torsion coil spring or leaf spring.

### LIST OF REFERENCE NUMERALS

10 . . . first housing

11 . . . housing body portion

12 . . . spring accommodating portion

13 . . . first terminal fitting

14 . . . resilient force accumulation chamber

15 . . . stopper

16 . . . first pressing portion (pressing portion)

17 . . . first guiding surface

18 . . . communication groove

19 . . . communication hole

20 . . . first holding portion (holding portion)

21 . . . first recess

22 . . . first pressure receiving portion (pressure receiving portion)

25 . . . spring member

26 . . . shaft-like supporting member

27 . . . shaft portion

28 . . . diameter-expanded portion

29 . . . resilient force releasing chamber

30 . . . second housing

31 . . . terminal supporting portion

32 . . . receptacle

33 . . . second terminal fitting

34 . . . second pressing portion (pressing portion)

35 . . . second guiding surface

36 . . . bulging portion

37 . . . second recess

38 . . . second pressure receiving portion (pressure receiving portion)

39 . . . second holding portion (holding portion)

40 . . . first housing

41 . . . first terminal fitting

42 . . . working chamber

43 . . . upper wall portion

44 . . . cut portion

45 . . . escape groove

46 . . . first guide groove

47 . . . second guide groove

48 . . . holding portion

49 . . . first pressing portion (pressing portion)

50 . . . first pressure receiving portion (pressure receiving portion)

51 . . . guide surface

52 . . . guide pin

55 . . . slider

56 . . . guide rib

57 . . . cam functioning portion

58 . . . cam groove

58E . . . entrance of cam groove

59 . . . third guide groove

60 . . . fourth guide groove

61 . . . spring supporting portion

62 . . . slit

63 . . . facing portion

64 . . . stopper

65 . . . spring member

66 . . . receiving member

67 . . . through hole

68 . . . sliding contact recess

70 . . . second housing

71 . . . terminal supporting portion

72 . . . receptacle

73 . . . second terminal fitting

74 . . . upper surface wall of receptacle

75 . . . second pressing portion (pressing portion)

76 . . . cam pin

77 . . . second pressure receiving portion (pressure receiving portion)

1. A connector, comprising:
a first housing;
a second housing connectable to and separable from the first housing;
a spring member constituted by a compression coil spring having an axis oriented in parallel to connecting and separating directions of the first and second housings;
a pressing portion arranged at a position to accumulate a resilient force in the spring member according to connection of the first and second housings;
a pressure receiving portion arranged to receive a resilient restoring force in a direction to connect the first and second housings from the spring member having the resilient force accumulated therein; and
a holding portion for holding the spring member in a resilient force accumulating state of accumulating the resilient force by the pressing portion only from start to a halfway state of the connection of the first and second housings,
the spring member being switched from the resilient force accumulating state to a resilient force releasing state of applying the accumulated resilient force to the pressure receiving portion by moving in a direction orthogonal to an axial direction of the spring member.

2. The connector of claim 1, wherein:
the pressing portion and the pressure receiving portion are arranged adjacent to each other,
the pressing portion has a guiding surface, and
the guiding surface guides to move the spring member toward a resilient force releasing position for applying the resilient restoring force toward the pressure receiving portion.

3. The connector of claim 2, wherein:
an axis of the spring member is oriented in a direction intersecting a guiding direction by the guiding surface, and
the spring member is externally fit to a shaft-like supporting member.

4. The connector of claim 1, comprising:
a slider provided in the first housing; and
a cam functioning portion provided in the slider and the second housing, the cam functioning portion moving the slider to a state switching position according to a connecting operation of the first and second housings,
wherein:
the slider is slidable in a direction intersecting the connecting direction of the first and second housings while holding the spring member, and
the spring member in the resilient force accumulating state is switched to the resilient force releasing state of applying the resilient restoring force to the pressure receiving portion if the slider moves to the state switching position.

5. The connector of claim 4, wherein:
the cam functioning portion includes a cam groove formed in the slider and a cam pin formed on the second housing, and
the cam pin is formed to receive the resilient restoring force of the spring member as the spring member is switched from the resilient force accumulating state to the resilient force releasing state.
